(19) United States
(12) Patent Application Publication
(10) Pub. No.: US 2004/0229002 A1
(43) Pub. Date: Nov. 18, 2004

(54) Stereolithographic seal and support structure for semiconductor wafer

(75) Inventors: Stewart A. Davis, La Habra, CA (US); Grant R. Flaharty, Agua Dulce, CA (US)

Correspondence Address: 3D Systems, Inc., 26081 Avenue Hall, Valencia, CA, 91355, US

(73) Assignee: 3D Systems, Inc.

(21) Appl. No.: 10/440,624

(22) Filed: May 15, 2003

(51) Int. Cl. B32B 3/02

(52) U.S. Cl. 428/64.1

(57) ABSTRACT

A support structure is applied directly to the first side of a semiconductor work piece or wafer by a stereolithographic process layer by layer completely about and extending inwardly of the periphery of the wafer, but external to the selected area within which a desired circuitry pattern is placed, the support structure being of a desired height and of a material resistive to an acid etch process effective to seal the circuitry pattern in the selected area from acid when the work piece is subjected to an acid etch on the opposing second side and about the periphery. The support structure further strengthens the work piece against flexural failure.

### BACKGROUND OF THE INVENTION

1. Field of the Invention

The present invention relates generally to semiconductor work pieces or wafers and, more particularly, to the use of stereolithography to create a fixture to hold the work piece in position within a coating system and the sealing barrier or support structure that is built stereolithographically about the periphery of the work piece.

2. Description of the Related Art

A manufacturing technique known as stereolithography, which utilizes layer by layer manufacturing of UV curable photopolymers, has been developed to a sufficient degree to permit its widespread use in multiple industries. Stereolithography, as conventionally practiced, utilizes a computer to generate a three-dimensional mathematical simulation or a model of an object to be fabricated, normally generating the simulation or model by converting computer-aided design (CAD) data into a file format known as .stl. The mathematical simulation is mathematically separated or sliced into cross-sections which are used in a vertical assembly of superimposed layers to create the desired three-dimensional object. This process was originally described in U.S. Pat. No. 4,575,330 to Hull and is currently assigned to the assignee of the present invention. The slicing techniques employed in stereolithography are described in U.S. Pat. Nos. 5,059,359; 5,184,307; 5,345,391; and 5,137,662, all issued to Hull et al. and assigned to the assignee of the present invention.

The application of sterelithography has evolved initially from early rapid fabrication of molds and prototypes of objects from CAD files to developing and refining object designs of relatively inexpensive materials and, more recently, to directly manufacturing relatively small quantities of objects where it is economically prohibitive to employ conventional fabrication techniques. Custom fabrication of products has become more widely accepted and explored. Most recently, stereolithography has been used to apply material to substrates with preformed electronic components, resulting in structures with the high degree of precision that stereolithography affords. This is especially helpful in the manufacture of semiconductor wafers or work pieces. This approach has been especially actively pursued in packaging of semiconductor dice and the creation of encapsulated semiconductor wafers or work pieces. Micron Technology, Inc. of Boise, Id. has been particularly active in patenting and publishing applications related to the use of stereolithography in the production of semiconductor devices. The following table lists the relevant publications pursued by Micron Technology, Inc.

U.S. Pat. No. 6,326,698 B1
U.S. Pat. No. 6,337,122 B1
U.S. Pat. No. 6,500,746 B2
U.S. Pat. No. 6,506,671 B1
U.S. Patent Application Publication No. 2001/0035597 A1
U.S. Patent Application Publication No. 2002/0006501 A1
U.S. Patent Application Publication No. 2002/0018871 A1
U.S. Patent Application Publication No. 2002/0195748 A1
U.S. Patent Application Publication No. 2003/0003179 A1
U.S. Patent Application Publication No. 2003/0003180 A1
U.S. Patent Application Publication No. 2003/0003380 A1
U.S. Patent Application Publication No. 2003/0003405 A1
U.S. Patent Application Publication No. 2003/0022462 A1

As the evolution of the application of stereolithography to semiconductor work pieces or wafers has progressed, there has been an increased desire to create thinner work pieces or wafers. The semiconductor devices are placed on a substrate and it is the excess substrate that is removed, usually by an acid etch process. For example, where the substrate is silicon, the excess silicon on the reverse side from the semiconductor devices is etched away by a particular acid etch mixture. One problem that arises with this process is the relative fragility of the already thin work pieces or wafers. The work pieces are easily fractured. During the etching process chips or cracks also can occur in the edge or periphery of the work piece. The chips can lead to cracks, or the cracks themselves will propagate and run through the work piece or wafer, essentially ruining the semiconductor devices that had been applied to the substrate. There is a need for a way to strengthen these work pieces to reduce their vulnerability to flexural stress and where fracture does occur, to salvage some of the semiconductor devices.

Additionally, where an acid etch process is employed, one approach has used a technique that places the semiconductor work piece on a carrier or chuck device to hold the wafer in place while the unlithographed side free of any semiconductor devices is etched away. This approach requires the use of some sealing means to prevent the highly corrosive acid solution from getting into the area where the circuitry patterns are applied to the working side of the substrate. Any seal or barrier must be precisely and accurately placed, resistant to the acid etch solutions, and be easily removable without damaging the semiconductor devices within the selected area of the wafer upon completion of the acid etch or back-etch process.

These problems are solved by the present invention which supplies a support structure that sealingly emplaces a barrier about the periphery of the semiconductor work piece or wafer to simultaneously strengthen the wafer and prevent the incursion of corrosive acid etch solution into the area containing the semiconductor devices during the acid etch process.

### BRIEF SUMMARY OF THE INVENTION

It is an aspect of the present invention that a UV curable stereolithographic seal or barrier and support structure for semiconductor work pieces or wafers is provided by stereolithographically creating a fixture to hold and place the work piece or wafer within the coating system, thereby building a barrier about the periphery of the wafer external to the circuitry pattern embedded on the wafer.

It is another aspect of the present invention that a vision system is used to ensure precise and accurate exposure of the UV curable material to ensure the precise and accurate creation and placement of the support structure.

It is a feature of the present invention that the seal or barrier and support structure is of sufficient thickness to resist an acid etch process and prevent damage from occurring to the semiconductor devices or circuitry patterns on the front or first side of the semiconductor work piece interiorly of the structure in a selected area of the work piece.

It is another feature of the present invention that the support structure is of sufficient height to prevent acid from overflowing into the circuitry pattern area during the etching process in a device or carrier used to accomplish the etching.

It is another feature of the present invention that a UV curable stereolithographic resin is used to provide an acid resistant material that forms the support structure and serves as the seal and barrier to the impingement of acid into the circuitry pattern.

It is an advantage of the present invention that the support structure is a sealing barrier that is built directly onto the semiconductor work piece or wafer.

It is another advantage of the present invention that the support structure increases the strength of the semiconductor work piece or wafer and makes it more resistive to flexural failure and easier to handle.

It is still another advantage of the present invention that the support structure helps prevent cracking and chipping about the periphery of the semiconductor work piece or wafer that destroys semiconductor devices in the wafer.

It is another advantage of the present invention that the support structure serves as a barrier and an effective seal against the corrosive acids used to acid etch excess substrate, such as silicon, from the semiconductor work piece on the opposing second side during a back etch process.

These and other aspects, features and advantages are obtained by the use of stereolithography to create directly on the work piece a barrier and seal that serves as a support structure for the semiconductor work piece and prevents the incursion of corrosive acids into the area containing the semiconductor devices. The support structure is applied directly to a first side of a work piece on which in a selected area there is a desired circuitry pattern. The support structure is applied layer by layer in a stereolithographic process completely about and interiorly of the periphery of the work piece, but external to the selected area; the support structure being of a desired height and of a material resistive to an acid etch process effective to seal the circuitry pattern in the selected area from acid when the work piece is subjected to an acid etch on its opposing second side and about the periphery. The support structure further strengthens the work piece against flexural failure.

### BRIEF DESCRIPTION OF THE DRAWINGS

These and other aspects, features and advantages of the invention will become apparent upon consideration of the following detailed disclosure of the invention, especially when it is taken in conjunction with the accompanying drawings wherein:

FIG. 1 is an exploded perspective view showing the semiconductor work piece with the circuitry pattern thereon and the stereolithographic fixture created to retain the semiconductor work piece in place during the building of the support structure;

FIG. 2 is a detailed view of a portion of the periphery of the semiconductor work piece and the support structure taken about the circular portion 2 of FIG. 1; and

FIG. 3 is a sectional view of the edge of the semiconductor wafer and the support structure taken along the lines 3-3 of FIG. 1.

### DETAILED DESCRIPTION OF THE INVENTION

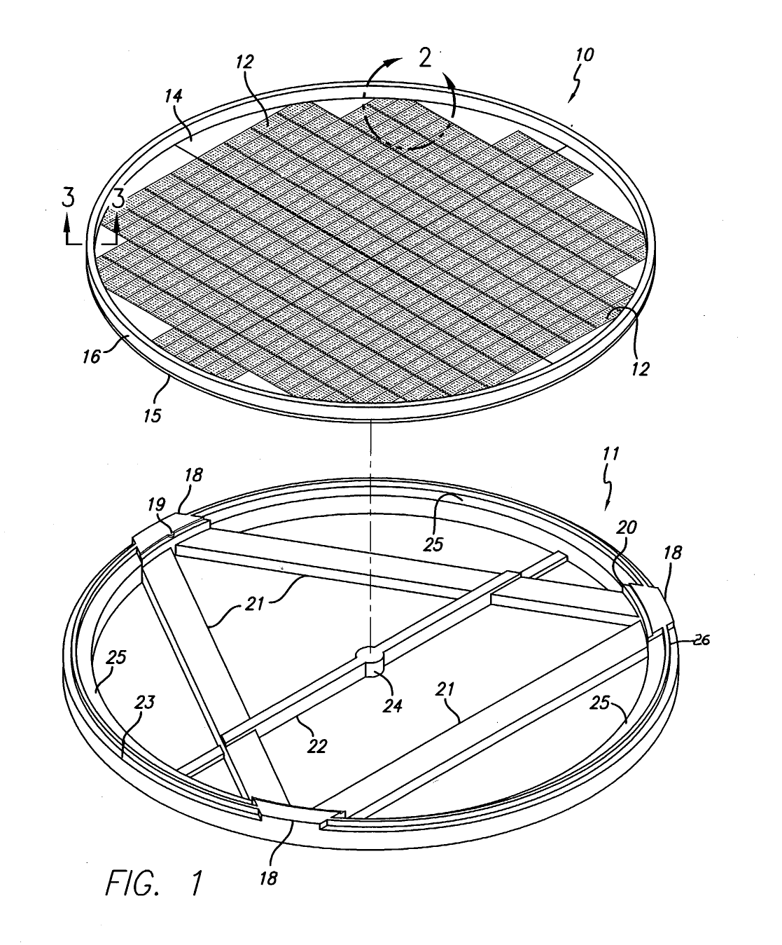

FIG. 1 shows in exploded view fashion the semiconductor work piece indicated generally by the numeral 10 and the fixtured device indicated generally by the numeral 11 that is used to retain the work piece 10 in position during the stereolithographic building process. Work piece 10 is seen as having a number of semiconductor devices 12 that have been embedded or applied to the first side 14 of the wafer 10 by a lithographic or microlithographic process. The second opposing side 17 of the semiconductor work piece 10 (see briefly FIG. 3) does not have any semiconductor devices on it and is generally a smooth surface comprised of the substrate material. The semiconductor devices 12 are lithographically placed on the substrate on the first side 14. The number of semiconductor devices 12 placed on the first side of the work piece 10 can vary and is normally referred to as the device count or device density on wafer. The density can vary from one to as many as several hundred, depending on the size of the wafer and the type and size of the semiconductor devices. The wafer or work piece 10 is normally circular but can be of any geometric shape such as rectangular or square. If circular, the size can vary from among a 4 inch (100 mm.), 6 inch (150 mm.), 8 inch (200 mm.), 10 inch (250 mm.), or 12 inch (300 mm.) diameter wafer. The substrate is preferably silicon, although it can be any variety of materials including aluminum titanium carbide or silicon germanium. Work piece 10 is shown as having a periphery 15 with a support structure 16 attached directly to the first side that serves as a sealing barrier during a subsequent acid etch process.

As seen in FIG. 1, the fixture 11 has a shape that corresponds generally to the shape of the semiconductor wafer which, in this instance is preferably circular. The fixture 11 has abutments 18 about its periphery or outer support surface 23 to engage the periphery 15 of the work piece 10 to hold the work piece in place during the stereolithographic process that creates the rim or support structure 16. A recessed lip 25 about the outer surface 23 serves to hold the photocurable resin so that the edge of the work piece is coated as needed and edge retraction of the photocurable resin on the wafer and the support structure 16 is minimized or avoided. Outer support surface 23 can also have a raised portion 26 on its upper surface above recessed lip 25. On one of the abutments 18, there is an alignment nib 19 that is utilized to mate with the corresponding alignment notch (not shown) in the work piece 10 for positioning on the fixture 11. In the preferred design, abutments 18 have a support step 20 on which the work piece 10 rests. Triangularly patterned arms 21 provide a support for the semiconductor work piece 10, along with central arm 22 which has a raised center section 24 to reduce the flexing of the semiconductor work piece at the center of the work piece.

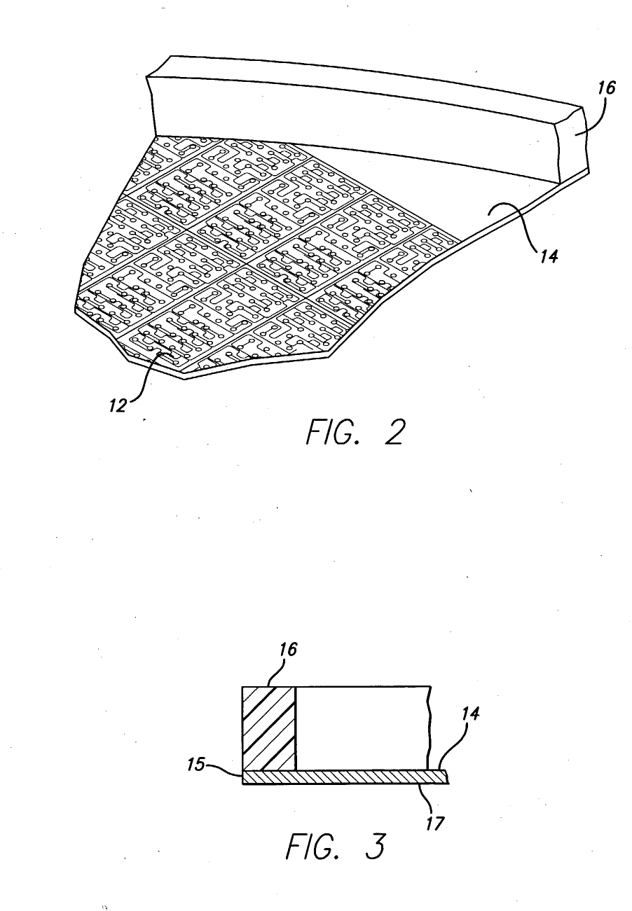

As best seen in FIGS. 1 and 2, the support structure 16 is affixed about the periphery 15 of the work piece 10. The support structure 16 is created through a stereolithographic process that utilizes an appropriate coating system. In a preferred embodiment, any stereolithography system, such as an SLA®3500 or SLA® Viper si2 system available from 3D Systems, Inc. of Valencia, Calif. is employed to build the fixture 11 and subsequently, after the work piece 10 is placed on the fixture, the support structure 16. The basic stereolithographic process is described in U.S. Pat. No. 4,575,330 to Hull and assigned to the assignee of the present invention. In that process, a support platform is lowered into a vat of photocurable resin which is then exposed, preferably by an ultraviolet beam of light to polymerize and photoharden the exposed material to form a three-dimensional object layer by layer. The platform is lowered one layer at a time into the photocurable resin as each cross-section of the part to be built is exposed by UV light, preferably in the form of a laser beam. In the present invention, the fixture 11 is first created on a support platform of an appropriate system (not shown). The fixture 11 is affixed to the support platform (not shown) during the build process and is raised above the surface of the photocurable resin in the vat upon completion of its build to receive the semiconductor work piece 10. Other suitable coating systems may obviate the need for a vat of liquid.

After completion of the now raised fixture 11, the work piece 10 is snapped into place inside of the abutments 18 and aligned by the alignment nib 19. The abutments 18 retain the wafer or work piece 10 in position so that the stereolithographic vision system ensures accurate exposure of the photocurable resin material used to form the support structure 16 during the subsequent build process. The support structure 16 is built, again in a layerwise fashion, about the periphery 15 of the work piece 10, ensuring that the support structure 16 does not extend or intrude into the selected area on which the circuitry pattern forming the semiconductor devices 12 has been placed. The semiconductor devices 12 are created by a separate lithographic or other appropriate process to form them on the semiconductor work piece or wafer 10. The photocurable or photopolymer resin adheres directly to the work piece 10 to form an effective seal against the top or first side 14 of the semiconductor work piece 10.

FIG. 3 shows the support structure 16 being aligned directly with the periphery 15 of the work piece 10. Alternatively, the support structure 16 can be inset slightly from the periphery 15 as long as it does not intrude into the selected area so that it remains in the exclusion zone, encompassing that area in which the circuitry patterns of the semiconductor devices 12 are placed, as best seen in FIG. 1. A coating, such as a single layer, of the photopolymer resin (not shown) can also be applied across the top of the first side 14 of the work piece 10 on the raw wafer to provide a coating that partially encapsulates the work piece 10 before the circuitry patterns are emplaced, or after the placement of the circuitry patterns during the building of the first layer of the support structure 16 or after the completion of the support structure. The fixture 11 can be used to retain the work piece 10 during the coating step.

Upon completion of the building of the support structure 16 and optionally the application of an encapsulating layer of a photopolymer resin, the semiconductor work piece 10 is removed from the coating system and its fixture 11 and exposed to a post-curing apparatus wherein UV light is applied to fully cure the material. U.S. Pat. No. 5,164,128 to Modrek et al. and assigned to the assignee of the present invention describes an appropriate post-curing process that can be employed. Once fully cured, the work piece 10 with the support structure 16 has added strength against flexural stress and can be then processed by back-etching to remove excess substrate from the opposing second side of the work piece 10.

The support structure 16, whether in its “green” state or after additional post-curing, adds strength to the thin and flexible work piece 10. The back-etching process is performed to obtain a thinner wafer that has several inherent advantages. First, the thinner wafer or work piece 10 retains less heat and can have improved heat dissipation properties in a working device since more heat can be conducted out through an appropriate heat sink. Additionally, the thinner microchips can be stacked one atop of another and thinner microchips may be employed in a wider range of applications, including “smart cards.” The support structure 16 also protects the edge or periphery 15 of the work piece 10, keeping it from cracking or chipping. The cracking, if unchecked, can propagate across the entire work piece 10, making it worthless. The primary value, however, of the support structure 16 lies in its ability to protect the semiconductor devices on its first side 14 from attack by the highly corrosive acids used in the acid etching process, as well as strengthening the wafer during handling especially after the wafer has been thinned by etching. The support structure 16 can also reduce the loss of valuable semiconductor devices on wafers where cracking may have occurred by containing the crack propagation and supplying support to the thin wafer so some semiconductor devices can be salvaged.

This acid etching process employs the use of a suitable carrier or chuck (not shown) which holds the work piece 10 with the semiconductor devices 12 facing upwardly. A vacuum can be used to draw the work piece 10 down onto the carrier. An acid mixture comprised of 49% concentrated hydrofluoric acid, 70% concentrated nitric acid, and 85% concentrated phosphoric acid, is employed in two different mixtures. One mixture can have a ratio of approximately 1:3:3 and the other can have a mixture ratio of approximately 1:7:7. This is used to back-etch, for example when silicon is used, the excess silicon from the second opposing side 17 of the work piece until a desired thickness is obtained. The original work piece thickness can be from about 700 to 750 microns or more in thickness but can be reduced to a thickness of something less than one-seventh that thickness. The thinner the final thickness, the wider the potential application of the finished wafer. The bath chemistry balance is observed in the acid etch to accurately control the time of exposure, such as by using electrical resistance measurements, to obtain the desired thickness. At the appropriate time, the acid etch is removed from the carrier device and the reduced thickness work piece is ready for removal of the support structure 10, such as by cutting with a diamond bladed saw.

The thickness of the support structure 16 that serves as the barrier and the seal to the acid mixture can range from about 0.1 inches to about 0.8 inches in thickness and have a height of from about 0.060 to about 0.2 inches, depending upon the particular carrier structure and other design attributes. The support structure 16 not only is an effective barrier and seal, but it also is resistive to the acid etch mixture.

A suitable stereolithography resin is that sold commercially by 3D Systems, Inc. as Accura® si 40 resin. This resin contains at least one polymerizing organic substance, having at least one alicyclic epoxide with two epoxide groups, at least one free-radical polymerizing substance including at least one aromatic di(meth)acrylate compound and optionally a tri-or higher functional methacrylate compound, at least one hydroxyl functional aromatic compound and appropriate cationic and free-radical polymerization initiators. Upon polymerization the resin has proven resistant to acid etch compositions. Other stereolithography resins may also be employed dependent upon their resistiveness to the particular acid etch compositions employed.

While the invention has been described above with reference to specific embodiments thereof, it is apparent that many changes, modifications and variations can be made without departing from the inventive concept disclosed herein. For example, a suitable coating system may include a three-dimensional ink jet printing system that utilizes photocurable resins as the jetting material to create the support structure or to apply an encapsulating layer of resin on the work piece or wafer. Accordingly it is intended to embrace all such changes, modifications and variations that fall within the spirit and broad scope of the accompanying. All patents and patent applications referenced herein are hereby specifically incorporated by reference in pertinent part.

What is claimed:

1. A semiconductor work piece having a substrate with a first side and an opposing second side, the first side having a desired circuitry pattern thereon within a selected area, the substrate having a periphery within which is the selected area, comprising:
a support structure applied directly to the first side by a stereolithographic process layer by layer completely about and extending inwardly of the periphery but external to the selected area, the support structure being of a desired height and of a material resistive to an acid etch process effective to seal the circuitry pattern in the selected area from acid when the work piece is subjected to an acid etch on the opposing second side and about the periphery, the support structure further strengthening the work piece against flexural failure.

2. The work piece according to claim 1 wherein the support structure is inset inwardly from the periphery.

3. The semiconductor work piece according to claim 1 wherein the support structure abuts the periphery.

4. The semiconductor work piece according to claim 1 wherein the desired height of the support structure is between about 0.060 to about 0.2 inches.

5. The semiconductor work piece according to claim 4 wherein the support structure has a thickness of about 0.1 to about 0.8 inches.

6. The semiconductor work piece according to claim 1 wherein the support structure is generally circular.

7. The semiconductor work piece according to claim 1 wherein the support structure is rectangular or square.

8. The semiconductor work piece according to claim 1 wherein the support structure is an acid resistant UV curable material having at least one polymerizing organic substance, at least one free-radical polymerizing organic substance, and at least one hydroxyl-functional aromatic compound.

9. The semiconductor work piece according to claim 1 wherein the circuitry pattern is applied via lithography.

10. The semiconductor work piece according to claim 1 wherein the support structure is removed after the acid etch.

11. The semiconductor work piece according to claim 1 wherein the semiconductor work piece further is contained in a fixture built stereolithographically in a coating system prior to placement of the semiconductor work piece within the system for creation of the support structure.

12. The semiconductor work piece according to claim 11 wherein the fixture conforms to the shape of the semiconductor work piece and has abutments spaced about the periphery of the semiconductor work piece to retain the semiconductor work piece.

13. The semiconductor work piece according to claim 11 wherein the coating system is a stereolithography system.

14. The semiconductor work piece according to claim 11 wherein the the coating system is an ink jet system.

15. A support fixture for receiving a semiconductor work piece and a semiconductor work piece having a substrate with a first side and an opposing second side, the first side having a desired circuitry pattern thereon within a selected area, the substrate having a periphery within which is the selected area, comprising in combination:
the work piece having a support structure applied directly to the first side by a stereolithographic process layer by layer completely about and extending inwardly of the substrate periphery but external to the selected area, the support structure being of a desired height and of a material resistive to an acid etch process effective to seal the circuitry pattern in the selected area from acid when the work piece is subjected to an acid etch on the opposing second side and about the periphery, the support structure further strengthening the work piece against flexural failure; and
the support fixture built stereolithographically in a coating system prior to placement of the semiconductor work piece within the system for creation of the support structure, the support fixture further conforming to the shape of the semiconductor work piece and having abutments positioned about the substrate periphery to retain the semiconductor work piece.
